(19) United States
(12) Patent Application Publication
(10) Pub. No.: US 2012/0283028 A1
(43) Pub. Date: Nov. 8, 2012

(54) FLEXIBLE COUPLING AND VEHICLE MOTIVE POWER TRANSMISSION APPARATUS

(76) Inventor: Takayuki Abe, Toyota-shi (JP)

(21) Appl. No.: 13/518,408

(22) PCT Filed: Dec. 8, 2010
(86) PCT No.: PCT/IB2010/003148

§ 371 Date: Jun. 22, 2012

(30) Foreign Application Priority Data
Dec. 25, 2009 (JP) 2009-294967

(51) Int. Cl. F16D 3/62

(52) U.S. Cl. 464/69

(57) ABSTRACT

A flexible coupling includes: spool members disposed equidistantly on a circumference; torque transmission lines disposed around adjacent pairs of the spool members; and an annular elastic body in which the spool members and the torque transmission lines are embedded. The torque transmission lines consist of first torque transmission lines, and second torque transmission lines whose total sum of cross-sectional area is a half of that of the first torque transmission lines. The flexible coupling is constructed so that the first torque transmission lines transmit positive torque and the second torque transmission lines transmit negative torque, and is incorporated into a vehicle motive power transmission apparatus that has a hypoid gear whose mesh transmission error is greater during transmission of negative torque than during transmission of positive torque.

### CROSS-REFERENCE TO RELATED APPLICATIONS

This application is a national phase application of International Application No. PCTAB2010/003148, filed Dec. 8, 2010, and claims the priority of Japanese Application No. 2009-294967, filed Dec. 25, 2009, the content of both of which is incorporated herein by reference.

### BACKGROUND OF THE INVENTION

1. Field of the Invention

The invention relates to a flexible coupling that links rotary shafts to transmit rotating torque and that absorbs vibration and flexure, and to a vehicle motive power transmission apparatus that has the flexible coupling.

2. Description of the Related Art

A flexible coupling is sometimes used to link rotary shafts of a vehicle, such as a propeller shaft, or the like (e.g., see Japanese Patent Application Publication No. 2003-28189 (JP-A-2003-28189)).

This flexible coupling is constructed of: spool members (referred to as “thread spools” in Japanese Patent Application Publication No. 2003-28189 (JP-A-2003-28189)) that are disposed at equal intervals on a circumference about the rotation axis as a center; torque transmission lines (referred to as “link belts” in Japanese Patent Application Publication No. 2003-28189 (JP-A-2003-28189)) that are wrapped in a loop manner around each two of the spool members that are next to each other in the circumferential direction; and an annular rubber member in which the spool members and the torque transmission lines are embedded.

The spool members consist of drive source-side spool members fixed to a drive source-side rotary shaft, and driving wheel-side spool members fixed to a driving wheel-side rotary shaft. Besides, the torque transmission lines consist of positive torque transmission lines that bear tension when the propeller shaft transmits positive torque, and negative torque transmission lines that bear tension when the propeller shaft transmits negative torque, and the number of turns of the positive torque transmission lines and the number of turns of the negative torque transmission lines are equal (e.g., see paragraph [0021] and FIG. 1 in Japanese Patent Application Publication No. 2003-28189 (JP-A-2003-28189)). It is to be noted herein that the positive torque is torque in such a direction as to accelerate the vehicle forward, and the negative torque is opposite in direction to the positive torque.

For example, as shown in FIG. 10, the flexible coupling 90 is linked between an input shaft 31 of a differential gear device 30 and a propeller shaft 20. An arrowed line T1 in FIG. 10 shows the rotation direction in which the input shaft 31 and a hypoid pinion 34 that is provided on an end portion of the input shaft 31 so as to rotate together with the input shaft 31 rotate when the propeller shaft 20 rotates in the normal direction. Besides, an arrowed line T2 shows the rotation direction in which a hypoid ring gear 35 rotates in mesh with the hypoid pinion 34 when the hypoid pinion 34 rotates in the normal direction. The rotation direction shown by the arrowed line T2 is also a direction in which the hypoid ring gear 35 rotates when the vehicle travels forward.

Each of the hypoid pinion 34 and the hypoid ring gear 35, as well known, has an asymmetrical tooth shape with respect to the rotation direction thereof. In the view of FIG. 10, the axis line N1 of the hypoid pinion 34 extends below the axis line N2 of the hypoid ring gear 35 that extends perpendicularly to the sheet of the drawing of FIG. 10.

Therefore, as for the hypoid gears 34 and 35, the direction of the mesh action line at the time of transmitting positive torque and the direction of the mesh action line at the time of transmitting negative torque are asymmetrical to each other. This will be explained with reference to FIGS. 11A, 11B, 12A and 12B. In FIGS. 11A, 11B, 12A and 12B, the X-axis coincides with the longitudinal direction of a vehicle, and the Y-axis coincides with the up-down direction of the vehicle, and the Z-axis coincides with the axis line of the hypoid ring gear 35. Besides, reference character 36 represents a bearing that supports the input shaft 31.

FIGS. 11A and 11B show illustrations in which a vector V1 represents the force that the hypoid pinion 34 receives from the hypoid ring gear 35 when the differential gear device 30 transmits positive torque. As shown in these illustrations, the X component, the Y component and the Z component of the vector V1 are 0.8, 0.7 and 0.1, respectively. FIGS. 12A and 12B are illustrations in which a vector V2 represents the force that the hypoid pinion 34 receives from the hypoid ring gear 35 when the differential gear device 30 transmits negative torque. As shown in these illustrations, the X component, the Y component and the Z component are −0.4, −0.7 and −0.6, respectively. Incidentally, the vectors V1 and V2 were obtained as results of a simulation that was performed with regard to an example of the differential gear device 30.

While the absolute values of the Y component of the vector V1 and the vector V2 are equal, the absolute value of the Z component is much larger in the vector V2 than in the vector V1. The Y component and the Z component are components of the force that are orthogonal to the axis line of the input shaft 31 of the differential gear device 30, and are components that act as a bending moment on the input shaft 31. Therefore, if the input torque value is fixed, larger bending moment occurs on the input shaft 31 when the hypoid gears 34 and 35 transmit negative torque than when the hypoid gear 34 and 35 transmit positive torque. That is, when negative torque is transmitted, the input shaft 31 bends greater and the mesh transmission error of the hypoid gears 34 and 35 becomes greater than when positive torque is transmitted.

In general, the greater the mesh transmission error of gears, the greater the gear noise is, so that the noise vibration (NV) transmitted into the cabin of a vehicle from the differential gear device 30a and from a vehicle motive power transmission apparatus that includes the differential gear device 30 is likely to be greater during transmission of negative torque than during transmission of positive torque. Then, in many cases, exhaust noise, engine vibration, etc. are smaller during transmission of negative torque than during transmission of positive torque. Therefore, there is a problem of the NV being likely to be recognized by occupants in the cabin when negative torque is transmitted.

Besides, the related-art flexible coupling has another problem as follows. That is, according to the related art, when a flexible coupling is to be designed, the number of turns of a torque transmission line which satisfies a design strength that is needed in order to transmit positive torque in a vehicle motive power transmission apparatus is determined, and the same number of turns is adopted for the positive torque transmission line and for the negative torque transmission line. That is, the positive torque transmission line and the negative torque transmission line have not been designed differently in the number of turns. However, since the absolute value of the maximum value of the torque that is transmitted by a flexible coupling in a vehicle motive power transmission apparatus is much greater for positive torque than for negative torque, the design strength of the negative torque transmission lines is greater than necessary in the related art.

### SUMMARY OF THE INVENTION

The invention has been made in view of the foregoing problems, and provides a flexible coupling which reduces the peak value of NV that occurs when a vehicle motive power transmission apparatus transmits negative torque, and which makes it possible to mitigate the greater-than-necessary design strength of the negative torque transmission line, and also provides a vehicle motive power transmission apparatus equipped with the flexible coupling.

According to one aspect of the invention, there is provided a flexible coupling including: at least four spool members disposed at equal intervals on a circumference about a rotation axis; torque transmission lines wrapped around spool members of the at least four spool members which are next to each other in a circumferential direction; and an annular elastic body in which the spool members and the torque transmission lines are embedded, wherein the torque transmission lines include first torque transmission lines and second torque transmission lines that are arranged alternately in the circumferential direction, and characteristics of the first torque transmission lines and the second torque transmission lines are set so that torsional rigidity is lower when the second torque transmission lines transmit torque than when the first torque transmission lines transmit torque.

If the flexible coupling having the foregoing construction is applied to a vehicle motive power transmission apparatus that includes a gear device that has a hypoid gear whose mesh transmission error is different between during transmission of positive torque and during transmission of negative torque, and if a construction is made such that the first torque transmission lines transmit positive torque, and the second torque transmission lines transmit negative torque, it is possible to lower the peak value of the NV that occurs in the motive power transmission apparatus. Besides, in the foregoing construction, characteristics of the first torque transmission lines and the second torque transmission lines are set so that torsional rigidity is less when the second torque transmission lines transmit torque than when the first torque transmission lines transmit torque. Usually, since the strength of the second torque transmission lines is smaller than the strength of the first torque transmission lines, the greater-than-necessary design strength of the negative torque transmission lines can be mitigated. Incidentally, the foregoing characteristics include, for example, the diameter of the torque transmission lines, the material thereof, the number of turns thereof, etc.

Besides, a total sum of cross-sectional area of the second torque transmission lines may be made less than a total sum of cross-sectional area of the first torque transmission lines so that the torsional rigidity is lower when the second torque transmission lines transmit torque than when the first torque transmission lines transmit torque.

The flexible coupling having this construction is also able to achieve the foregoing operation and effects when applied to a vehicle motive transmission apparatus that includes a gear device that has a hypoid gear whose mesh transmission error is different during transmission of positive torque and during transmission of negative torque.

Besides, in the foregoing construction of the flexible coupling, a diameter of the first torque transmission lines and a diameter of the second torque transmission lines may be equal to each other, and a number of turns of the second torque transmission lines may be less than a number of turns of the first torque transmission lines.

According to the flexible coupling having the foregoing construction, since the number of turns of the second torque transmission lines is less than the number of turns of the first torque transmission lines, the number of man-hours needed to wrap the second torque transmission lines in the manufacturing of the flexible coupling can be reduced in comparison with the manufacturing of the related-art flexible coupling in which the number of turns of the second torque transmission lines is equal to that of the first torque transmission lines.

According to another aspect of the invention, there is provided a motive power transmission apparatus including: the flexible coupling as described above; a drive source-side rotary shaft and a driving wheel-side rotary shaft that are linked by the flexible coupling so as to rotate together; and a gear device that is linked to a rotary shaft that is one of the drive source-side rotary shaft and the driving wheel-side rotary shaft so as to rotate together with the rotary shaft, wherein the spool members are fixed alternately in the circumferential direction to the drive source-side rotary shaft and to the driving wheel-side rotary shaft so that the first torque transmission lines transmit positive torque and the second torque transmission lines transmit negative torque. In this apparatus, the gear device may have a hypoid gear whose mesh transmission error is greater during transmission of the negative torque than during transmission of the positive torque.

According to the vehicle motive power transmission apparatus having the foregoing construction, it is possible to lower the peak value of the NV that occurs in the motive power transmission apparatus.

Besides, in the foregoing construction of the vehicle motive power transmission apparatus in accordance with the invention, the total sum of cross-sectional area of the second torque transmission lines may be set so as to minimize a peak value of a frequency response characteristic of mesh-point-generated force of the hypoid gear.

According to the vehicle motive power transmission apparatus having this construction, it is possible to most greatly reduce the peak value of the NV of the motive power transmission apparatus.

Besides, in the foregoing construction of the vehicle motive power transmission apparatus, the gear device may be a transmission provided between a drive source and the drive source rotary shaft. Furthermore, the flexible coupling may also be arranged so as to link the driving wheel-side rotary shaft and the drive source-side rotary shaft that is linked to the transmission.

Furthermore, the gear device may be a differential gear device provided between the driving wheel-side rotary shaft and a driving wheel. Still further, the flexible coupling may be arranged so as to link the drive source-side rotary shaft and the driving wheel-side rotary shaft that is linked to the differential gear device.

Besides, the motive power transmission apparatus may include two flexible couplings that are: the flexible coupling arranged so as to link the drive source-side rotary shaft and the driving wheel-side rotary shaft that is linked to the differential gear device; and the flexible coupling arranged so as to link the driving wheel-side rotary shaft and the drive source-side rotary shaft that is linked to the transmission. Due to the provision of the two flexible couplings of the invention between the transmission and the differential gear device, it becomes possible to further improve the NV characteristic of the vehicle motive power transmission apparatus.

According to the invention, the maximum value of the NV that occurs in the vehicle motive power transmission apparatus is reduced. Besides, according to the invention, the greater-than-necessary design strength of the negative torque transmission lines of the flexible coupling for use in a vehicle motive power transmission apparatus is mitigated.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a general plan view showing an example in which a vehicle motive power transmission apparatus in accordance with an embodiment of the invention is mounted in a motor vehicle;

FIG. 2 is a perspective view showing a state in which a propeller shaft and an input shaft of a differential gear device are linked by a flexible coupling in accordance with the embodiment of the invention;

FIG. 3 is a sectional view showing a state in which an output shaft of the transmission and a propeller shaft are linked by a flexible coupling in accordance with the embodiment of the invention;

FIG. 4 is a sectional view taken on line A-A in FIGS. 3 and 5, omitting illustration of components and the like other than the flexible coupling and connection members;

FIG. 5 is a sectional view showing a state in which a propeller shaft and an input shaft of a differential gear device are linked by a flexible coupling in accordance with the embodiment of the invention;

FIG. 6 is a graph showing frequency characteristics of the vibration-point compliance of hypoid pinions and a hypoid ring gear;

FIG. 7 is a graph showing frequency characteristics of the mesh-point compliance of hypoid gears;

FIG. 8 shows frequency characteristics of the mesh-point-generated forces of hypoid gears;

FIG. 9 shows frequency characteristics of the mesh-point-generated forces of hypoid gears in another embodiment of the invention;

FIG. 10 is a graph showing a positional relation among a propeller shaft, a flexible coupling, and a differential gear device;

FIGS. 11A and 11B are diagrams showing as a vector and the like a force that a hypoid pinion receives from a hypoid ring gear when a differential gear device transmits positive torque; and

FIGS. 12A and 12B are diagrams showing as a vector and the like a force that a hypoid pinion receives from a hypoid ring gear when a differential gear device transmits negative torque.

### DETAILED DESCRIPTION OF EMBODIMENTS

A flexible coupling and a vehicle motive power transmission apparatus in accordance with an embodiment of the invention will be described with reference to the drawings.

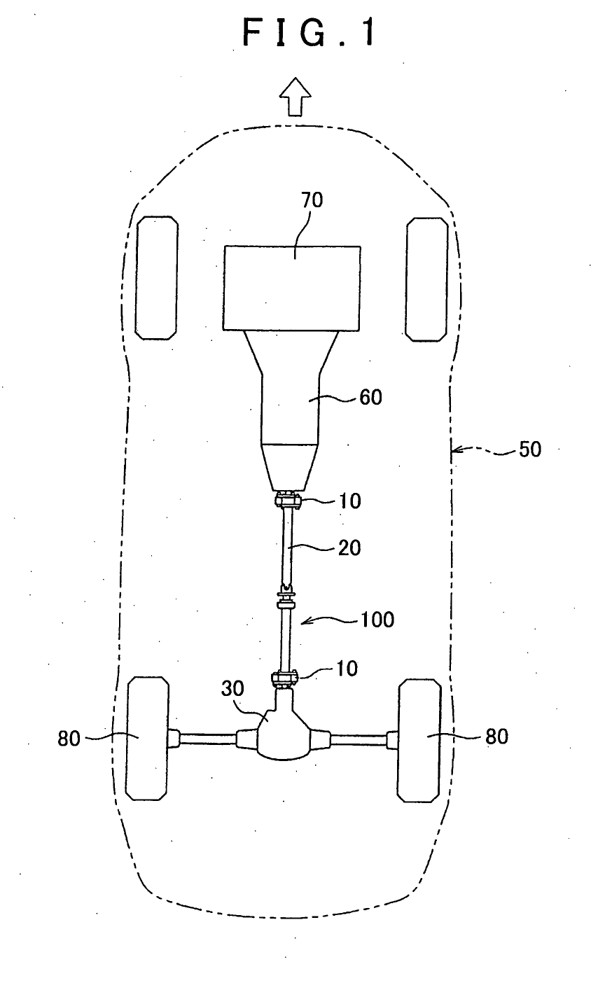

FIG. 1 is a plan view of an FR (front engine, rear wheel drive) type motor vehicle 50, showing an engine (drive source) 70, a transmission 60, a propeller shaft 20, a differential gear device 30, driving wheels 80, etc. The propeller shaft 20 is linked to an output shaft of the transmission 60 and to an input shaft of the differential gear device 30, respectively, via flexible couplings 10, so as to rotate integrally with the output shaft and the input shaft.

Incidentally, a motive power transmission apparatus (vehicle motive power transmission apparatus) 100 that transmits motive power of the engine 70 to the driving wheels 80 is constructed of the transmission 60, the front-side flexible coupling 10, the propeller shaft 20, the rear-side flexible coupling 10, the differential gear device 30, etc., which are provided between the engine 70 and the driving wheels 80.

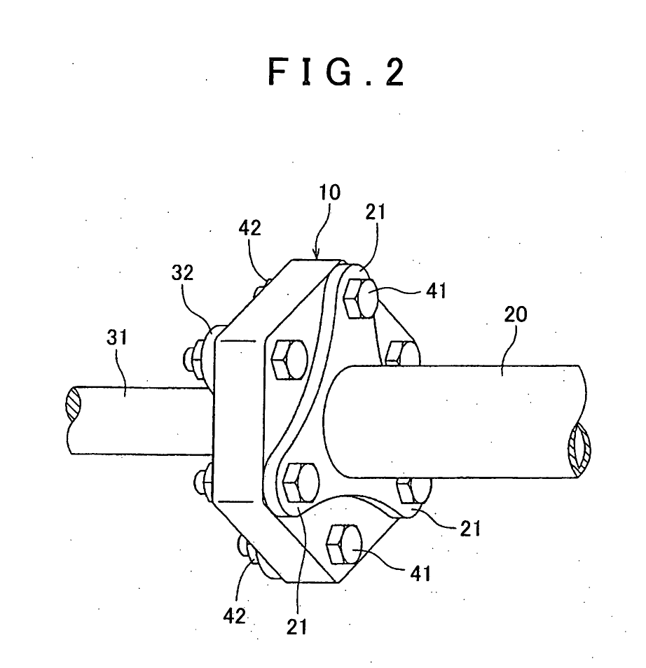

FIG. 2 shows a state in which a rear end portion of the propeller shaft 20 and the input shaft 31 of the differential gear device 30 are linked via the flexible coupling 10 so as to rotate together.

The rear end portion of the propeller shaft 20 is provided with a member that has three linking flanges 21 that are formed at equal intervals in a circumferential direction (at equal intervals of 120° in FIG. 2) and that extend radially outward. Likewise, a front end portion of the input shaft 31 of the differential gear device 30 is provided with a member that has three linking flanges 32 similar to the linking flanges 21. The linking flanges 21 and the linking flanges 32 face each other with a phase difference of 60° in the circumferential direction, and are fixed to the corresponding ones of the two opposite surfaces of the rear-side flexible coupling 10 by bolts 41 and nuts 42. Incidentally, although not shown in the drawings, the output shaft of the transmission 60 and a front end portion of the propeller shaft 20 are also provided with linking flanges that are similar to the foregoing linking flanges 21 and 32, and that also face each other with a phase difference of 60° in the circumferential direction and are fixed to the opposite surfaces of the front-side flexible coupling 10 by bolts and nuts.

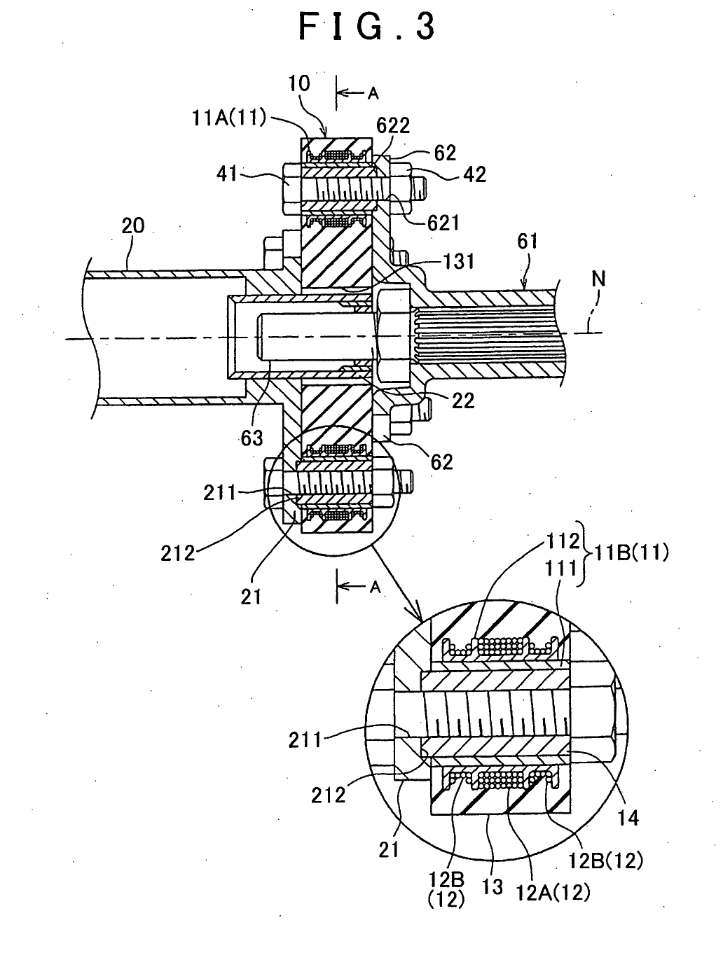

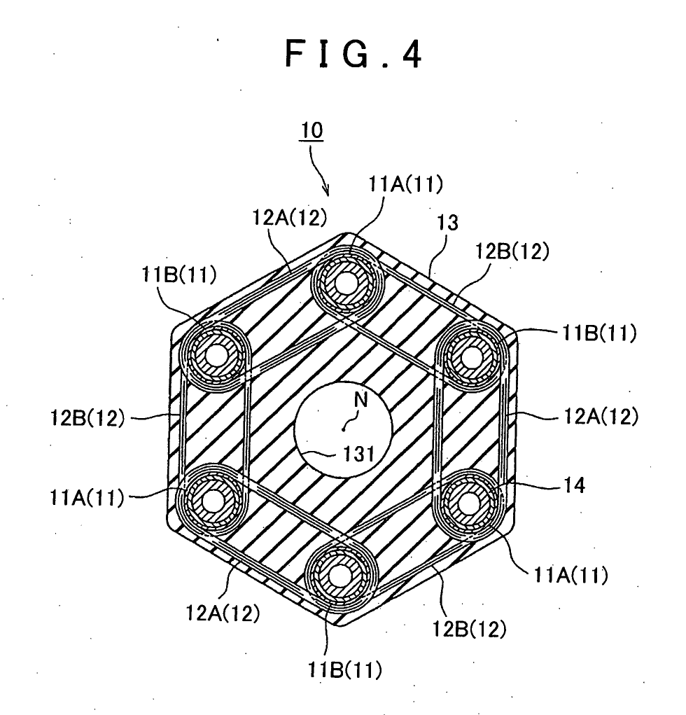

FIG. 3 shows a state in which the output shaft 61 of the transmission 60 and the front end portion of the propeller shaft 20 are linked via the flexible coupling 10 so as to rotate together. FIG. 4 shows a cross-sectional view taken on line A-A in FIG. 3.

As shown in FIG. 3 and FIG. 4, the flexible coupling 10 has: six spool members 11 disposed at equal intervals on a circumference about the rotation axis N as the center; torque transmission lines 12 that are wrapped around each two of the spool members 11 that are next to each other in the circumferential direction; and an annular elastic body 13 in which the spool members 11 and the torque transmission lines 12 are embedded.

The spool members 11 are provided as members on which to wrap or wind the torque transmission lines 12. Each of the spool members 11 is constructed, for example, as shown in FIG. 3, of a cylindrical sleeve 111, and a collar member 112 that is provided on an outer periphery of the sleeve 111 so as to restrict the torque transmission line 12 from moving in the thickness direction of the flexible coupling 10.

The spool members 11 are fixed to the linking flanges 62 of the output shaft 61 of the transmission 60 or to the linking flanges 21 of the propeller shaft 20, via fixture tools such as bolts 41 and nuts 42, etc.

Cylindrical connection members 14 are each press-fitted into a radially inward side of one of the spool members 11. An end portion of each connection member 14 is fitted into a circular recess portion 622 formed around a corresponding one of bolt insertion holes 621 that are formed in the linking flanges 62 provided on the rear end portion of the output shaft 61, or into a circular recess portion 212 formed around a corresponding one of bolt insertion holes 211 that are formed in the linking flanges 21 provided on the front end portion of the propeller shaft 20. Thus, the spool members 11 are defined in position in the circumferential direction relative to the propeller shaft 20 or the output shaft 61 via the connection members 14.

As shown in FIG. 3, the foregoing six spool members 11 consist of three drive source-side spool members 11A that are fixed to the linking flanges 62 of the output shaft 61, and three driving wheel-side spool members 11B that are fixed to the linking flanges 21 of the front end portion of the propeller shaft 20. The drive source-side spool members 11A and the driving wheel-side spool members 11B are alternately arranged in the circumferential direction.

The torque transmission lines 12 of the flexible coupling 10 are each wrapped, in a loop fashion and a multi-layer fashion, around one of the drive source-side spool members 11A and one of the driving wheel-side spool members 11B that is adjacent to the foregoing one of the drive source-side spool members 11A in the circumferential direction. The torque transmission lines 12 used herein are, for example, lines that are made up of a macromolecular material, such as polyester, nylon, etc., and that have a predetermined tensile strength.

The torque transmission lines 12 consist of positive torque transmission lines 12A (first torque transmission lines) that transmit positive torque and that bear tension when transmitting positive torque, and negative torque transmission lines 12B (second torque transmission lines) that transmit negative torque and that bear tension when transmitting negative torque. The positive torque transmission lines 12A and the negative torque transmission lines 12B are alternately arranged in the circumferential direction. In the flexible coupling 10 shown in FIGS. 3 and 4, the positive torque transmission lines 12A are wrapped at a central position in the width of the spool members 11, and the negative torque transmission lines 12B are wrapped at two opposite side positions in the width of the spool members 11.

The annular elastic body 13 is made of, for example, an elastomeric material such as rubber or the like, is molded in an annular shape with the spool members 11 and the torque transmission lines 12 embedded therein. The hole formed in a central portion of the annular elastic body 13 is a bush insertion hole 131 through which to insert a bush 22 and the like as described above.

As shown in FIG. 3, reference character 22 represents a cylindrical bush fixed to an end portion of the propeller shaft 20, and reference character 63 represents an inner shaft that is a portion of the output shaft 61 of the transmission 60. The bush 22 and the inner shaft 63 are used in an axis aligning operation when the output shaft 61 of the transmission 60 and the propeller shaft 20 are linked by the flexible coupling 10.

The flexible coupling 10 has positive torque transmission lines 12A and negative torque transmission lines 12B that have equal line diameters and are made of the same material. However, the positive torque transmission lines 12A and the negative torque transmission lines 12B are different in the number of turns and in the total sum of cross-sectional area. It is to be noted herein that the total sum of cross-sectional area is (the cross-sectional area of each torque transmission line)×(the number of turns)×2. Concretely, the number of turns (the total sum of cross-sectional area) of the positive torque transmission lines 12A is set on the basis of the maximum value of the positive torque that the flexible coupling 10 transmits, and a safety factor. On the other hand, the number of turns (the total sum of cross-sectional area) of the negative torque transmission lines 12B is designed to be less than the number of turns (the total sum of cross-sectional area) of the positive torque transmission lines 12A, and is set on the basis of the maximum value of the negative torque, and a safety factor. Generally, the maximum value of the negative torque assumed in design is less than or equal to ½ of the maximum value of the positive torque. Therefore, in this embodiment, the number of turns (the total sum of cross-sectional area) of the negative torque transmission lines 12B is ½ of the number of turns (the total sum of cross-sectional area) of the positive torque transmission lines 12A.

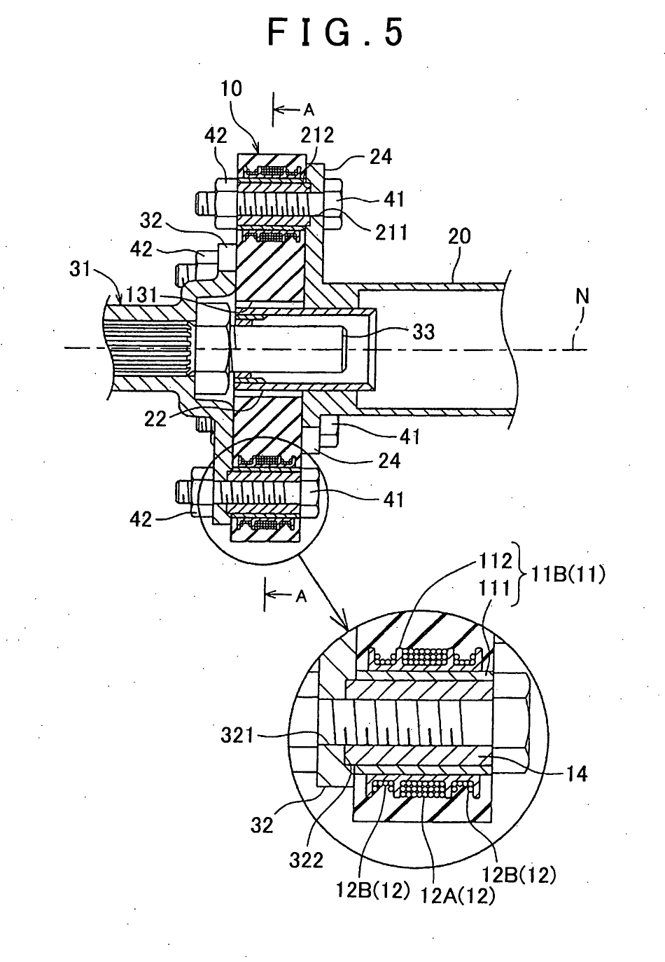

FIG. 5 shows a state in which the rear end portion of the propeller shaft 20 and the input shaft 31 of the differential gear device 30 are linked by the flexible coupling 10 so as to rotate together.

The six spool members 11 of the flexible coupling 10 shown in FIG. 5 consist of three drive source-side spool members 11A fixed to the linking flanges 24 of the rear end portion of the propeller shaft 20, and three driving wheel-side spool members 11B fixed to the linking flanges 32 provided on the input shaft 31 of the differential gear device 30. Besides, the flexible coupling 10 is linked to the propeller shaft 20 and to the input shaft 31 so that when the propeller shaft 20 transmits positive torque, tension occurs in the positive torque transmission lines 12A (first torque transmission lines), whose number of turns is greater than that of the negative torque transmission lines 12B, and so that when the propeller shaft 20 transmits negative torque, tension occurs in the negative torque transmission lines 12B (second torque transmission lines), whose number of turns is the smaller.

In FIG. 5, reference characters 211 and 321 represent insertion holes for bolts 41 which are provided in the linking flanges 24 and 32, and reference characters 212 and 322 represent circular recess portions that are provided around the insertion holes 24 and 32. As described above with reference to FIG. 3, an end portion of each connection member 14 is fitted into a corresponding one of the circular recess portions 212 and 322. Thus, likewise, the spool members 11 fitted over to the connection members 14 are defined in position in the circumferential direction relative to the propeller shaft 20 and the input shaft 31.

Besides, in FIG. 5, reference character 22 represents a cylindrical bush fixed to the end portion of the propeller shaft 20, and reference character 33 represents an inner shaft that is a portion of the input shaft 31 of the differential gear device 30. The bush 22 and the inner shaft 33 are used in an axis aligning operation when the propeller shaft 20 and the input shaft 31 of the differential gear device 30 are linked by the flexible coupling 10.

Of the other constructions shown in FIG. 5, constructions substantially the same as those described above with reference to FIG. 3 are represented by the same reference characters, and descriptions thereof will be omitted below.

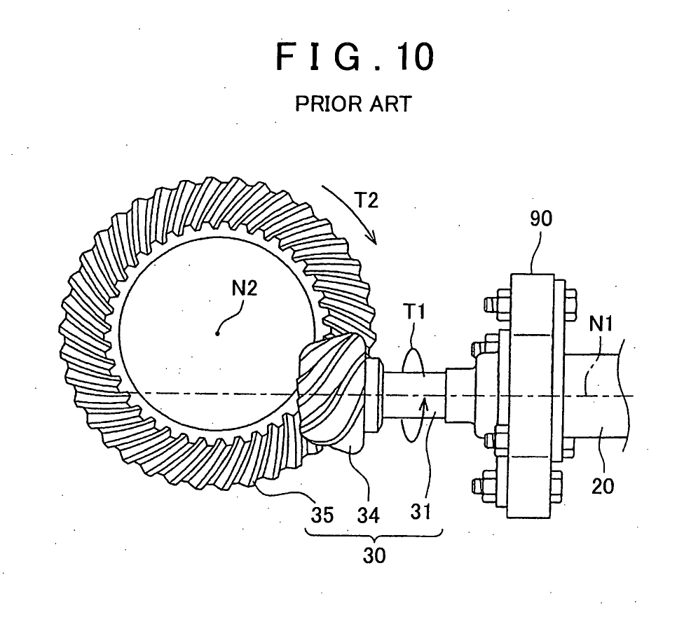

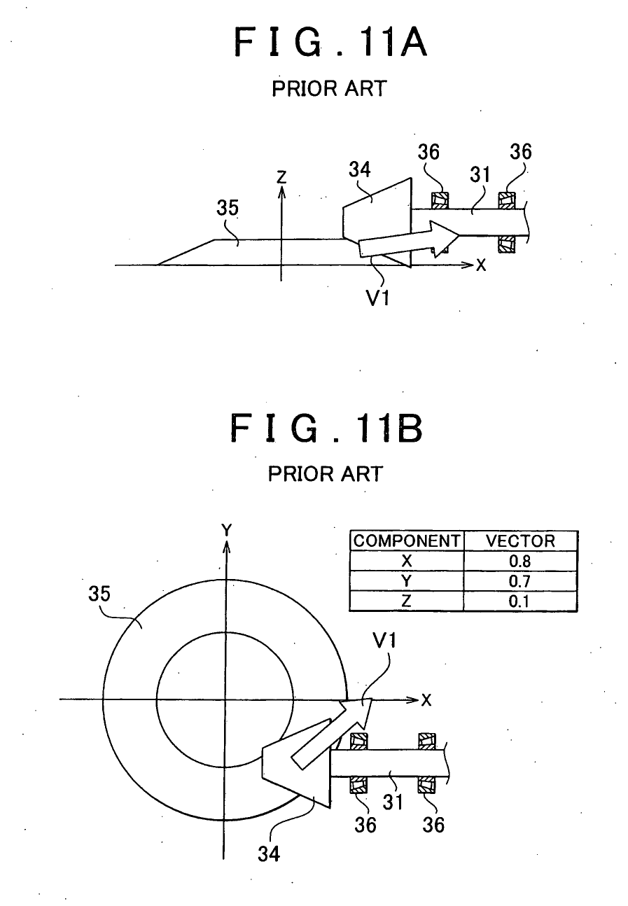

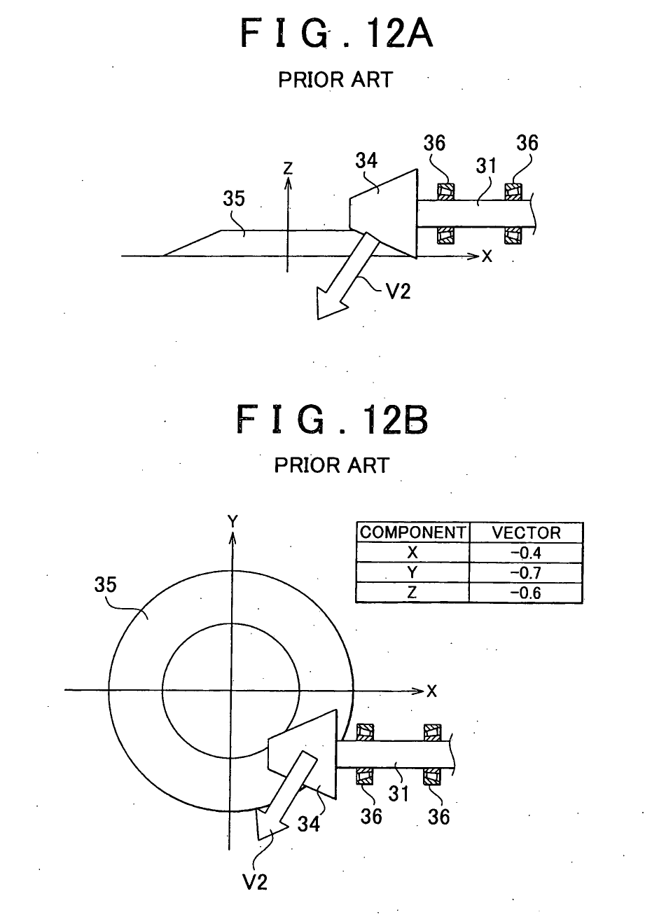

The differential gear device 30 is substantially the same as that is described above in “Description of the Related Art” with reference to FIG. 10. However, in this embodiment, the related-art flexible coupling 90 in the construction described above with reference to FIG. 10 is replaced by the flexible coupling 10 in accordance with the invention, that is, a flexible coupling in which the total sum of cross-sectional area of the positive torque transmission lines 12A is less than the total sum of cross-sectional area of the negative torque transmission lines 12B.

When the motive power transmission apparatus 100 incorporating the flexible coupling 10 transmits torque, mesh transmission error occurs between the hypoid pinion 34 and the hypoid ring gear 35, and the mesh transmission error causes a mesh-point-generated force that works as a vibromotive force.

The mesh-point-generated force vibrates the hypoid pinion 34 and the hypoid ring gear 35, and further vibrates the propeller shaft 20 that is a motive power transmission member that is linked to the hypoid pinion 34 and the hypoid ring gear 35, and also vibrates the flexible coupling 10, and the like, and therefore excites torsional vibration thereof. This torsional vibration turns into radiated sound, which is propagated in air into the cabin, and is also propagated thereinto as a solid propagated sound via bearings of the propeller shaft 20 and the like.

Therefore, in order to curb or reduce the peak value of the NV propagated into the cabin, it suffices to reduce the peak value of the mesh-point-generated force on the hypoid gears 34 and 35.

Incidentally, the mesh-point-generated force Fmesh [N] is expressed as in the following expression (1) using the mesh transmission error δTE [m] and the mesh-point compliance Hmesh [m/N].

Fmesh=δTE/Hmesh (1)

Besides, the mesh-point compliance Hmesh is expressed as in the following expression (2) using a vibration-point compliance Hpini that occurs when only the hypoid pinion 34 is vibrated by a unit vibration force in the direction of the mesh action line, and a vibration-point compliance Hring that occurs when only the hypoid ring gear 35 is likewise vibrated.

Hmesh=Hpini+Hring (2)

The vibration-point compliance is a frequency response function, and depends on torsional rigidity of a member that is linked so as to rotate integrally with the hypoid pinion 34 or the hypoid ring gear 35. Therefore, in this embodiment, the vibration-point compliance Hpini depends on the torsional rigidity of the flexible coupling 10 that is linked to the hypoid pinion 34 so as to rotate integrally therewith.

As is apparent from the expression (1), it is effective to increase the bottom value of the mesh-point compliance Hmesh, in order to lower the peak value of the mesh-point-generated force Fmesh. In this embodiment, in order to reduce the NV occurring during transmission of negative torque, the torsional rigidity of the flexible coupling 10 during transmission of negative torque is reduced by making the total sum of cross-sectional area (number of turns) of the negative torque transmission lines 12B of the flexible coupling 10 less than the total sum of cross-sectional area (number of turns) of the positive torque transmission lines 12A (equivalent to the negative torque transmission lines of the related-art flexible coupling), so that the bottom value of the mesh-point compliance Hmesh will be raised.

Next explained will be the reason why the bottom value of the mesh-point compliance Hmesh is raised by reducing the torsional rigidity of the flexible coupling 10 occurring during transmission of negative torque. Incidentally, in the following explanation, “n” represents the total sum of cross-sectional area of the positive torque transmission lines 12A of the flexible coupling 10 in accordance with the invention, and “n/2” represents the total sum of cross-sectional area of the negative torque transmission lines 12B of the flexible coupling 10 in accordance with the invention, and “n” also represents the total sum of cross-sectional area of the positive torque transmission lines of the related-art flexible coupling 90, and “n/2” also represents the total sum of cross-sectional area of the negative torque transmission lines of the related-art flexible coupling 90. The value “n” is a predetermined value.

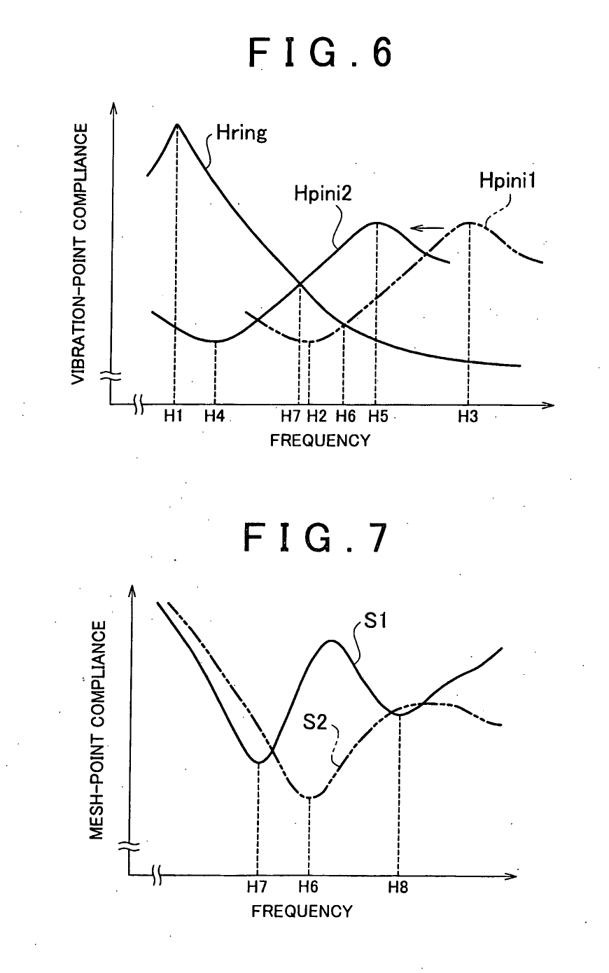

FIG. 6 shows frequency characteristics of the vibration-point compliance Hpini of the hypoid pinion 34 and of the vibration-point compliance Hring of the hypoid ring gear 35 during transmission of negative torque which were determined by using an FEM (finite element method). In FIG. 6, the vertical axis shows the logarithmic value of the vibration-point compliance (20 log₁₀ Hpini or 20 log₁₀ Hring), and the horizontal axis shows the frequency (Hz).

In FIG. 6, the curve Hring shows the frequency characteristic of the vibration-point compliance Hring of the hypoid ring gear 35. This curve Hring forms a peak value at a frequency H1, and generally declines as the frequency heightens above the frequency H1. Besides, the curve Hpini1 shown by a two-dot dashed line shows the frequency characteristic of the vibration-point compliance of the hypoid pinion 34 in the case where in the motive power transmission apparatus 100 in accordance with the invention, the flexible couplings 10 in accordance with the invention provided for linking the two opposite ends of the propeller shaft 20 to other transmission members are replaced by the related-art flexible couplings 90. This curve Hpini1 forms a bottom value at a frequency H2, and forms a peak value at a frequency H3. The curve Hpini2 shown by a solid line shows the frequency characteristic of the vibration-point compliance of the hypoid pinion 34 in the case where the flexible couplings 10 in accordance with the invention are applied as flexible couplings for linking the two end portions of the propeller shaft 20 to other transmission members (i.e., in the case where the motive power transmission apparatus 100 in accordance with the invention is constructed). This curve Hpini2 forms a bottom value at a frequency H4, and forms a peak value at a frequency H5.

Then, the frequency characteristic of the vibration-point compliance of the hypoid pinion 34 changes from the curve Hpini1 to the lower frequency side, and becomes as shown by the curve Hpini2, if the total sum of cross-sectional area of the negative torque transmission lines is halved, and the torsional rigidity of the flexible coupling 10 during transmission of negative torque is lowered. As a result, the frequency characteristic of the mesh-point compliance Hmesh that satisfies the relation of the expression (2) also changes.

FIG. 7 is a graph that illustrates the foregoing change in the frequency characteristic of the mesh-point compliance Hmesh. A curve 51 in FIG. 7 shows the frequency characteristic of the mesh-point compliance of the hypoid gears 34 and 35 in the motive power transmission apparatus 100 in accordance with the invention. Besides, a curve S2 shows the frequency characteristic of the mesh-point compliance of the hypoid gears 34 and 35 in the case where in the motive power transmission apparatus 100 in accordance with the invention, the two flexible couplings 10 are replaced by the related-art flexible couplings 90. Incidentally, in FIG. 7, the vertical axis shows the logarithmical value of the mesh-point compliance (20 log₁₀ Hmesh), and the horizontal axis shows the frequency (Hz).

If the frequency characteristic of the vibration-point compliance of the hypoid pinion 34 changes from the curve Hpini1 to the lower frequency side and comes to be shown by the curve Hpini2 as shown in FIG. 6, the frequency characteristic of the mesh-point compliance Hmesh shown in FIG. 7 changes from the curve S2 to the curve 51, involving a change from a bottom value at a frequency H6 to a raised bottom value at a frequency H7.

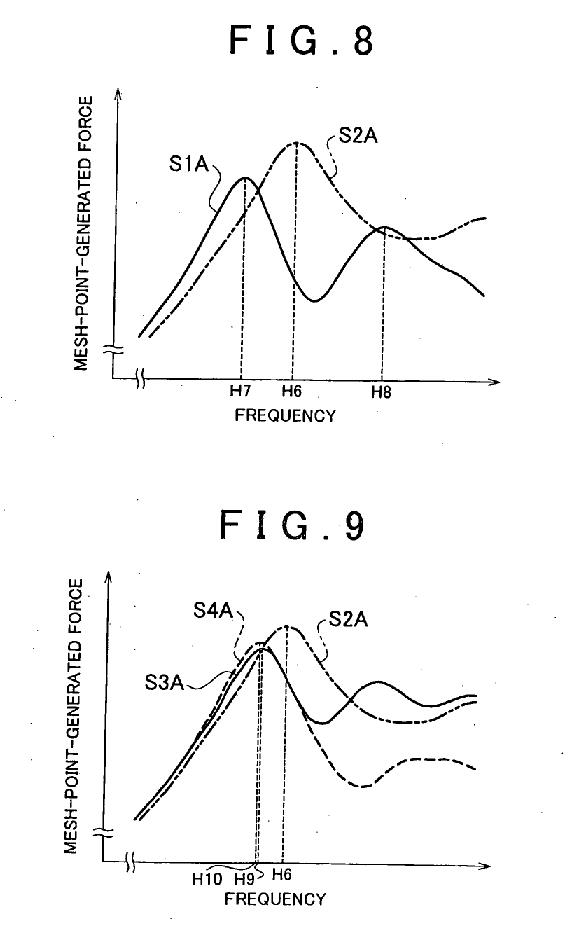

If the bottom value of the frequency characteristic of the mesh-point compliance Hmesh is raised in the foregoing manner, the peak value of the mesh-point-generated force Fmesh, which is a reciprocal number of the mesh-point compliance Hmesh, is reduced as shown in FIG. 8. That is, FIG. 8 shows the frequency characteristic of the mesh-point-generated force Fmesh of the hypoid gears 34 and 35 occurring during transmission of negative torque. In FIG. 8, a curve S1A shows the frequency characteristic of the mesh-point-generated force Fmesh of the hypoid gears 34 and 35 in the motive power transmission apparatus 100 in accordance with the invention. Besides, a curve S2A shows the frequency characteristic of the mesh-point-generated force Fmesh of the hypoid gears 34 and 35 in the case where in the motive power transmission apparatus 100 in accordance with the invention, the two flexible couplings 10 are replaced by the related-art flexible couplings 90. Incidentally, in finding the frequency characteristic of the mesh-point compliance Hmesh shown in FIG. 8, the mesh transmission error δTE is set as a constant (e.g., “1”). Incidentally, in FIG. 8, the vertical axis shows the logarithmic value of the mesh-point-generated force(20 log₁₀ Fmesh), and the horizontal axis shows the frequency (Hz).

As is apparent from the foregoing description, the torsional rigidity of the flexible coupling 10 during transmission of negative torque is lowered by reducing the total sum of cross-sectional area of the negative torque transmission lines of the flexible coupling to a half of that in the related art, so that the peak value of the mesh-point-generated force Fmesh is restrained. As a result, the peak value of the NV propagated into the cabin is also restrained.

Incidentally, if the curve Hpini2 representing the frequency characteristic of the vibration-point compliance of the hypoid pinion 34 shown in FIG. 6 is further moved to the lower frequency side by further lessening the total sum of cross-sectional area of the negative torque transmission lines 12B, the bottom value of the mesh-point compliance Hmesh lowers to a certain extent. However, if the total sum of cross-sectional area of the negative torque transmission lines 12B is made further smaller beyond a certain range, the bottom value of the mesh-point compliance Hmesh may sometimes take an upward turn.

Therefore, it is desirable to set the total sum of cross-sectional area of the negative torque transmission lines 12B so that the bottom value of the mesh-point compliance Hmesh maximizes within a predetermined frequency range (e.g., of 200 Hz to 1000 Hz), that is, so that the peak value of the mesh-point-generated force Fmesh reaches a minimum value within the same frequency range, by executing a calculation technique according to the FEM or the like, or performing experiments or the like. Of course, it is a prerequisite that the set total sum of cross-sectional area of the negative torque transmission lines 12B be within a range that satisfies the design strength required of the negative torque transmission lines 12B.

Besides, in the flexible coupling 10 in accordance with the invention, the torque transmission lines 12A, whose total sum of cross-sectional area is the greater, transmit positive torque and the torque transmission lines 12B, whose total sum of cross-sectional area is the smaller, transmit negative torque; therefore, the greater-than-necessary design strength of the negative torque transmission lines, which is mentioned above as a problem of the related-art flexible coupling 90, is mitigated.

In FIG. 9, a curve S3A shows the frequency characteristic of the mesh-point-generated force Fmesh of the hypoid gears 34 and 35 in the case where in the motive power transmission apparatus 100 in accordance with the invention, the flexible coupling 10 in accordance with the invention is applied between the propeller shaft 20 and the output shaft 61 of the transmission 60, and the related-art flexible coupling 90 is applied between the propeller shaft 20 and the input shaft 31 of the differential gear device 30. Besides, a curve S4A in FIG. 9 shows the frequency characteristic of the mesh-point-generated force Fmesh of the hypoid gears 34 and 35 in the case where in the motive power transmission apparatus 100 in accordance with the invention, the related-art flexible coupling 90 is applied between the propeller shaft 20 and the output shaft 61 of the transmission 60, and the flexible coupling 10 in accordance with the invention is applied between the propeller shaft 20 and the input shaft 31 of the differential gear device 30. Besides, the curve S2A in FIG. 9 is the same as the curve S2A described above with reference to FIG. 8. Incidentally, the frequency characteristics of the foregoing mesh-point-generated forces Fmesh in FIG. 9 are also found by using the FEM. The vertical axis represents the logarithmic value of the mesh-point-generated force (20 log₁₀ Fmesh), and the horizontal axis shows frequency (Hz) as in FIG. 8.

As shown in FIG. 9, with regard to the peak values of the curve S2A and the curves S3A ad S4A, the peak value of the curve S3A at a frequency H9 and the peak value of the curve S4A at a frequency H10 are lower than the peak value of the curve S2A at the frequency H6. Thus, it can be said to be possible to reduce the peak value of the NV by applying the flexible coupling 10 in accordance with the invention to at least one of the two flexible couplings provided for linking the two opposite ends of the propeller shaft 20 to transmission members such as a shaft and the like.

In the foregoing embodiment, although in the flexible coupling 10 in accordance with the invention, the total sum of cross-sectional area of the negative torque transmission lines 12B is set smaller than the total sum of cross-sectional area of the positive torque transmission lines 12A so that the torsional rigidity during the transmission of negative torque is smaller than the torsional rigidity during transmission of positive torque, the foregoing difference in torsional rigidity between during transmission of positive torque and during transmission of negative torque may also be realized by making the other characteristics or features (e.g., the material of the torque transmission lines 12, the number of turns thereof, etc.) different between positive torque transmission lines 12A and the negative torque transmission lines 12B.

The invention is applicable to, for example, flexible couplings disposed at the linking portions of the propeller shaft of a motor vehicle, and to a motive power transmission apparatus that has such flexible couplings.

1. A flexible coupling comprising:
at least four spool members disposed at equal intervals on a circumference about a rotation axis; torque transmission lines wrapped around spool members of the at least four spool members which are next to each other in a circumferential direction;
and an annular elastic body in which the spool members and the torque transmission lines are embedded, wherein
the torque transmission lines include first torque transmission lines and second torque transmission lines that are arranged alternately in the circumferential direction, and characteristics of the first torque transmission lines and the second torque transmission lines are set so that torsional rigidity is lower when the second torque transmission lines transmit torque than when the first torque transmission lines transmit torque.

2. The flexible coupling according to claim 1, wherein
a total sum of cross-sectional area of the second torque transmission lines is made less than a total sum of cross-sectional area of the first torque transmission lines so that the torsional rigidity is lower when the second torque transmission lines transmit torque than when the first torque transmission lines transmit torque.

3. The flexible coupling according to claim 2, wherein
a diameter of the first torque transmission lines and a diameter of the second torque transmission lines are equal to each other, and a number of turns of the second torque transmission lines is less than a number of turns of the first torque transmission lines.

4. A motive power transmission apparatus comprising:
the flexible coupling according to claim 1;
a drive source-side rotary shaft and a driving wheel-side rotary shaft that are linked by the flexible coupling so as to rotate together; and
a gear device that is linked to a rotary shaft that is one of the drive source-side rotary shaft and the driving wheel-side rotary shaft so as to rotate together with the rotary shaft, wherein
the spool members are fixed alternately in the circumferential direction to the drive source-side rotary shaft and to the driving wheel-side rotary shaft so that the first torque transmission lines transmit positive torque and the second torque transmission lines transmit negative torque.

5. The motive power transmission apparatus according to claim 4, wherein
the gear device has a hypoid gear whose mesh transmission error is greater during transmission of the negative torque than during transmission of the positive torque.

6. The motive power transmission apparatus according to claim 5, wherein
the total sum of cross-sectional area of the second torque transmission lines is set so as to minimize a peak value of a frequency response characteristic of mesh-point-generated force of the hypoid gear.

7. The motive power transmission apparatus according to claim 4, wherein
the gear device is a transmission provided between a drive source and the drive source-side rotary shaft.

8. The motive power transmission apparatus according to claim 7, wherein
the flexible coupling is arranged so as to link the driving wheel-side rotary shaft and the drive source-side rotary shaft that is linked to the transmission.

9. The motive power transmission apparatus according to claim 4, wherein
the gear device is a differential gear device provided between the driving wheel-side rotary shaft and a driving wheel.

10. The motive power transmission apparatus according to claim 9, wherein
the flexible coupling is arranged so as to link the drive source-side rotary shaft and the driving wheel-side rotary shaft that is linked to the differential gear device.

11. The motive power transmission apparatus according to claim 10, wherein
the motive power transmission apparatus includes two flexible couplings that are: the flexible coupling arranged so as to link the drive source-side rotary shaft and the driving wheel-side rotary shaft that is linked to the differential gear device; and the flexible coupling arranged so as to link the driving wheel-side rotary shaft and the drive source-side rotary shaft that is linked to the a transmission.
